(19) United States
(12) Patent Application Publication
(10) Pub. No.: US 2010/0269737 A1
(43) Pub. Date: Oct. 28, 2010

(54) SIGNAGE HOLDING CLIP

(76) Inventor: Bryan Jensen, Liberty Township, OH (US)

Correspondence Address: DINSMORE & SHOHL LLP, FIFTH THIRD CENTER, ONE SOUTH MAIN STREET, SUITE 1300, DAYTON, OH, 45402-2023, US

(21) Appl. No.: 12/765,515

(22) Filed: Apr. 22, 2010

Related U.S. Application Data
(60) Provisional application No. 61/171,638, filed on Apr. 22, 2009.

(51) Int. Cl. G09F 15/00; B65D 19/22; B65D 19/38

(52) U.S. Cl. 108/51.11; 40/611.12; 40/594

(57) ABSTRACT

Devices for holding signage on a pallet, methods of displaying signage on a pallet, pallets, and methods of utilization thereof. In one form, the device includes a mounting plate, a support plate integral with the mounting plate, and a signage support unit integral with the support plate. In one form, the method involves attaching a mounting plate to the pallet, such that a support plate is integrally formed with the mounting plate, positioning a support unit that is integrally formed with the support plate and has a channel configured to hold signage therein, and placing signage within the channel. In one form, the pallet includes a plurality of substantially horizontal members attached to a substantially rectangular frame, a mounting plate attached to at least one of the rectangular frame and the plurality of substantially horizontal members, a support plate integral with the mounting plate, and a signage support unit configured to hold signage therein.

This application claims priority to U.S. Provisional Application Ser. No. 61/171,638, filed Apr. 22, 2009, the contents of which are hereby incorporated by reference in its entirety.

### TECHNICAL FIELD

The present invention is generally directed to a clip for a pallet, and more specifically to a signage holding clip for displaying signage on a pallet.

### BACKGROUND

Pallets are commonly employed to transport goods, merchandise and/or related inventory in the retail industry. Often, sign assemblies are used in cooperation with pallets to identify goods in transit, merchandise, and/or related inventory. Various signage holding assemblies have been employed to display signs and/or advertising on pallets. However, current signage holding assemblies are difficult to attach to pallets, bulky in size, and difficult to assemble; moreover, current signage holding assemblies are not universally adaptable to fit different sizes, shapes and types of pallets. Thus, improvements to signage holding assemblies are needed.

### SUMMARY

These needs are met by the present invention, where according to one embodiment, a device for holding signage on a pallet is disclosed. The device comprises a mounting plate attachable to the pallet and having an outer edge, a support plate integral with the outer edge of the mounting plate and substantially normal to the mounting plate, and a signage support unit comprising a channel configured to hold signage therein. The signage support unit is integral with the support plate and the outer edge of the mounting plate, such that the signage support unit is substantially normal to the mounting plate and extends in a substantially vertical direction above the pallet.

Optionally, the device for holding signage on a pallet includes: a signage support unit comprising a plurality of elongate members integral with a base member; a signage support unit comprising a plurality of elongate members integral with a base member, wherein the plurality of elongate members are substantially parallel to one another, and the base member is substantially normal to the plurality of elongate members such that the signage support unit is substantially U-shaped; a signage support unit comprising a plurality of flexible members within the channel configured to hold signage therein; a signage support unit comprising a plurality of flexible members within the channel configured to hold signage therein, wherein the plurality of flexible members are integral with the plurality of elongate members; a signage support unit comprising a plurality of flexible members within the channel configured to hold signage therein, wherein the plurality of flexible members are integral with the plurality of elongate members and form a substantially a substantially 45° angle with the plurality of elongate members; a signage support unit comprising a plurality of flexible members within the channel configured to hold signage therein, wherein the plurality of flexible members are integral with the plurality of elongate members wherein the plurality of flexible members are arranged within the channel in an alternating configuration; a mounting plate comprising an upper surface and a lower surface; an adhesive disposed on the lower surface such that when the adhesive is placed in contact with the pallet, the mounting plate becomes secured thereto; a foam adhesive disposed on the lower surface such that when the adhesive is placed in contact with the pallet, the mounting plate becomes secured thereto; a device comprising metal; a device comprising metal wherein the metal is aluminum; a device comprising an extrudable plastic; and a device comprising an extrudable plastic wherein the extrudable plastic is selected from the group consisting of polyethylene polystyrene, and polytetrafluoroethylene.

In another embodiment, a method of displaying signage on a pallet which comprises utilizing the device for holding signage on a pallet of the present invention is disclosed.

In still another embodiment, a method of displaying signage on a pallet is disclosed. The method comprises attaching a mounting plate having an outer edge to the pallet, such that a support plate is integrally formed with the outer edge of the mounting plate and substantially normal to the mounting plate, positioning a signage support unit that is integrally formed with the support plate and comprises a channel configured to hold signage therein, such that the signage support unit is substantially normal to the mounting plate and extends in a substantially vertical direction above the pallet, and placing signage within the channel, such that signage is displayed on the pallet.

In yet still another embodiment, a pallet is disclosed. The pallet comprises a plurality of substantially horizontal members attached to a substantially rectangular frame, a mounting plate attached to at least one of the rectangular frame and to the plurality of substantially horizontal members, wherein the mounting plate has a outer edge, a support plate integral with the outer edge of the mounting plate and substantially normal to the mounting plate, and a signage support unit comprising a channel configured to hold signage therein. The signage support unit is integral with the support plate and the outer edge of the mounting plate, such that the signage support unit is substantially normal to the mounting plate and extends in a substantially vertical direction above the pallet.

Optionally, the pallet includes: a signage support unit comprising a plurality of elongate members substantially parallel to one another, and a base member substantially normal to the plurality of elongate members, such that the signage support unit is substantially U-shaped; a signage support unit comprising a plurality of flexible members within the channel configured to hold signage therein; and a mounting plate comprising an upper surface and a lower surface, wherein the lower surface comprises an adhesive, such that the mounting plate may be attached to the pallet.

These and other features and advantages of these and other various embodiments according to the present invention will become more apparent in view of the drawings, detailed description, and claims provided that follow hereafter.

### BRIEF DESCRIPTION OF THE DRAWINGS

The following detailed description of the embodiments of the present invention can be best understood when read in conjunction with the following drawings, where like structure is indicated with like reference numerals, and in which:

FIG. 1 is a side view of the device for holding signage on a pallet according to one embodiment of the present invention;

FIG. 2 is a side perspective view of the device for holding signage on a pallet according to one embodiment of the present invention shown from the opposite side of that of FIG. 1;

FIG. 3 is a back view of the device for holding signage on a pallet according to one embodiment of the present invention;

FIG. 4 is a top view of the device for holding signage on a pallet according to one embodiment of the present invention; and

FIG. 5 is a front view of the device for holding signage on a pallet according to one embodiment of the present invention.

Skilled artisans appreciate that elements in the figures are illustrated for simplicity and clarity and have not necessarily been drawn to scale. For example, the dimensions of some of the elements in the figures may be exaggerated relative to other elements, as well as conventional parts removed, to help to improve understanding of the various embodiments of the present invention.

### DETAILED DESCRIPTION

The following term is used in the present application:

As used herein, the term “alternating configuration” refers to an arrangement of flexible members within a channel wherein each of the flexible members is positioned at substantially different vertical positions along elongate members.

Embodiments of the present invention relate to a device for holding signage on a pallet. The device comprises a mounting plate attachable to the pallet and having an outer edge, a support plate integral with the outer edge of the mounting plate and substantially normal to the mounting plate, and a signage support unit comprising a channel to hold signage therein. The signage support unit is integral with the support plate and the outer edge of the mounting plate, such that the signage support unit is substantially normal to the mounting plate and extends in a substantially vertical direction above the pallet. Embodiments of the present invention also relate to a pallet. Additionally, embodiments of the present invention relate to methods of displaying signage on a pallet and utilization thereof.

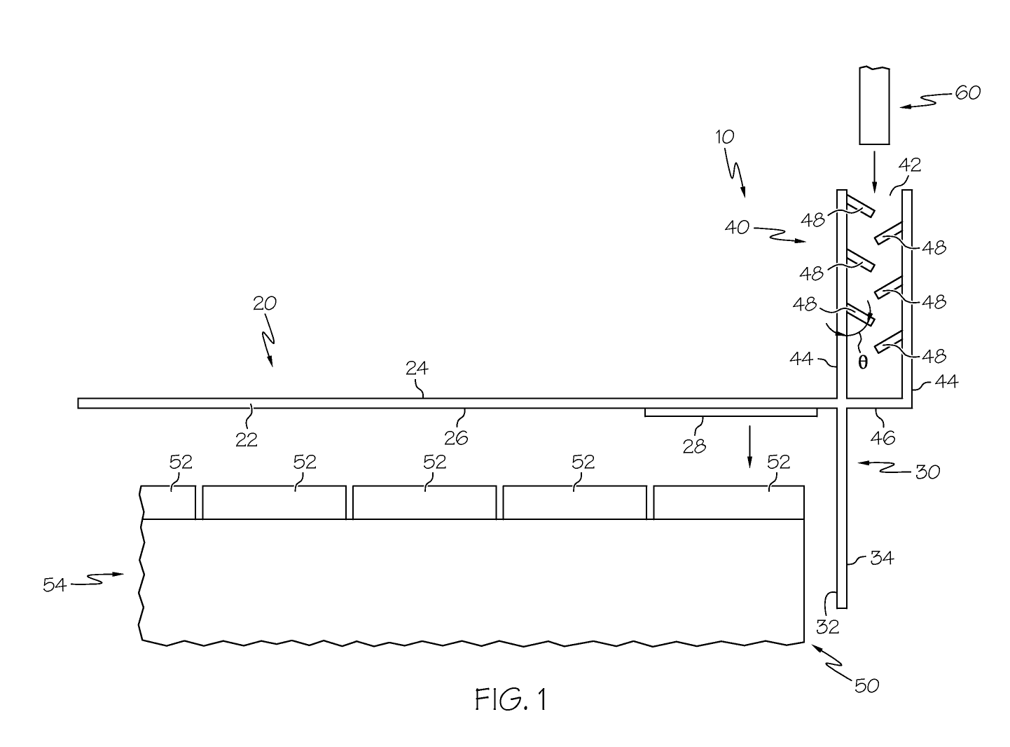

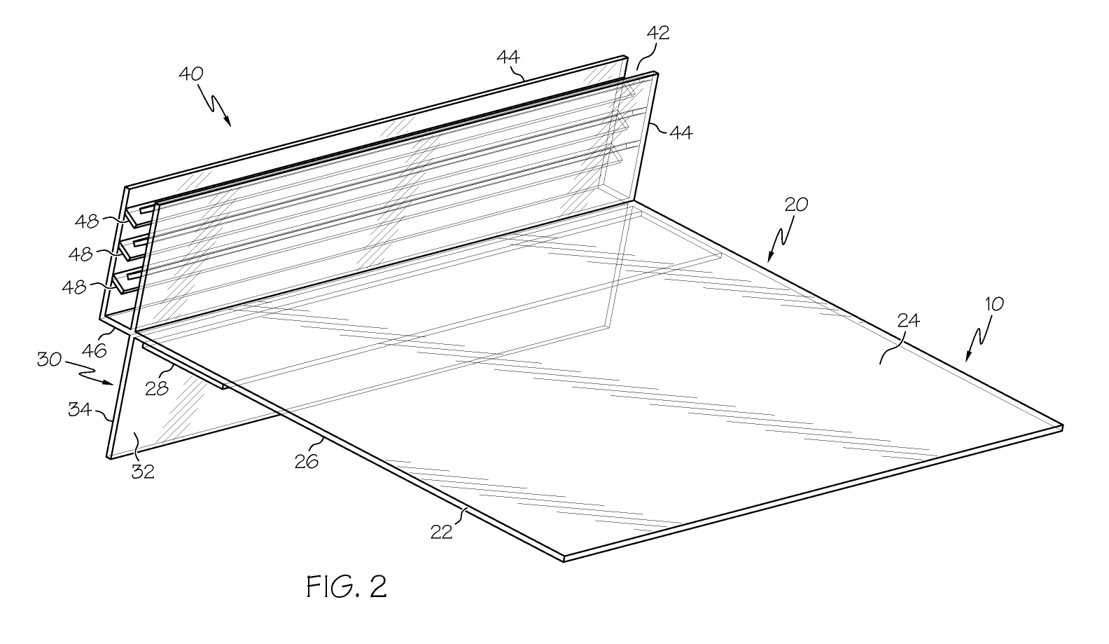

As shown in FIGS. 1 and 2, in one embodiment, the device 10 for holding signage 60 on a pallet 50 comprises a mounting plate 20, a support plate 30, and a signage support unit 40. In one aspect, the mounting plate 20 has an outer edge 22, an upper surface 24 and a lower surface 26. In one particular aspect, the mounting plate 20 is substantially planar. In a further aspect, the mounting plate 20 is about 50 mm thick. It is understood by one skilled in the art, however, that the mounting plate 20 can be extruded to a variety of thicknesses to accommodate different needs. In another aspect, the mounting plate 20 is substantially rectangular. However, the shape of the mounting plate 20 should not be limited to substantially rectangular, but may comprise any shape wherein the mounting plate 20 is attachable to the pallet 50. In one particular aspect, the mounting plate 20 comprises plastics, polymers, rubbers, metals, and/or composites, and combinations thereof. In a further aspect, the mounting plate 20 is aluminum. In an alternative aspect, the mounting plate 20 comprises an extrudable plastic. In a further aspect, the extrudable plastic is polyethylene, polystyrene, and/or polytetrafluoroethylene, and combinations thereof. In one particular aspect, the mounting plate 20 is substantially transparent to light in the visible region (having a wavelength, λ, from about 400 nm to about 700 nm) of the electromagnetic spectrum. In an alternative aspect, the mounting plate 20 is substantially nontransparent to light in the visible region (having a wavelength, λ, from about 400 nm to about 700 nm) of the electromagnetic spectrum.

In another aspect, the mounting plate 20 is attachable to the pallet 50. In one particular aspect, the pallet 50 comprises a plurality of horizontal members 52 attached to a substantially rectangular frame 54. In another aspect, the mounting plate 20 is attachable to the pallet 50 such that the mounting plate 20 is substantially parallel to the horizontal members 52 of the pallet 50. In a further aspect, the mounting plate 20 is attachable to the pallet 50 such that the lower surface 26 of the mounting plate 20 engages the horizontal members 52 of the pallet 50. In one particular aspect wherein the pallet 50 contains goods, merchandise and/or related inventory, the mounting plate 20 is attachable to the pallet 50 such that the mounting plate 20 slidably engages the pallet 50. In this particular aspect, the mounting plate 20 is attached to the pallet 50 by inserting the mounting plate 20 beneath the transport goods, merchandise, and/or related inventory and translating the mounting plate 20 in a substantially horizontal direction toward the opposing edge of the pallet 50.

In another aspect, the mounting plate 20 is attachable to the pallet 50 with an adhesive 28. In one particular aspect, the adhesive 28 is disposed on the lower surface 26 of the mounting plate 20 such that when the adhesive 28 is placed in contact with the pallet 50, the mounting plate 20 becomes secured thereto. In one aspect, the adhesive 28 is selected from natural adhesives, synthetic adhesives, drying adhesives and contact adhesives. In a further aspect, the adhesive 28 is a synthetic adhesive. In still a further aspect, the adhesive 28 is a foam adhesive. In yet still a further aspect, the thickness of the foam adhesive is about 1/16 in and the width of the foam adhesive is about 1 in.

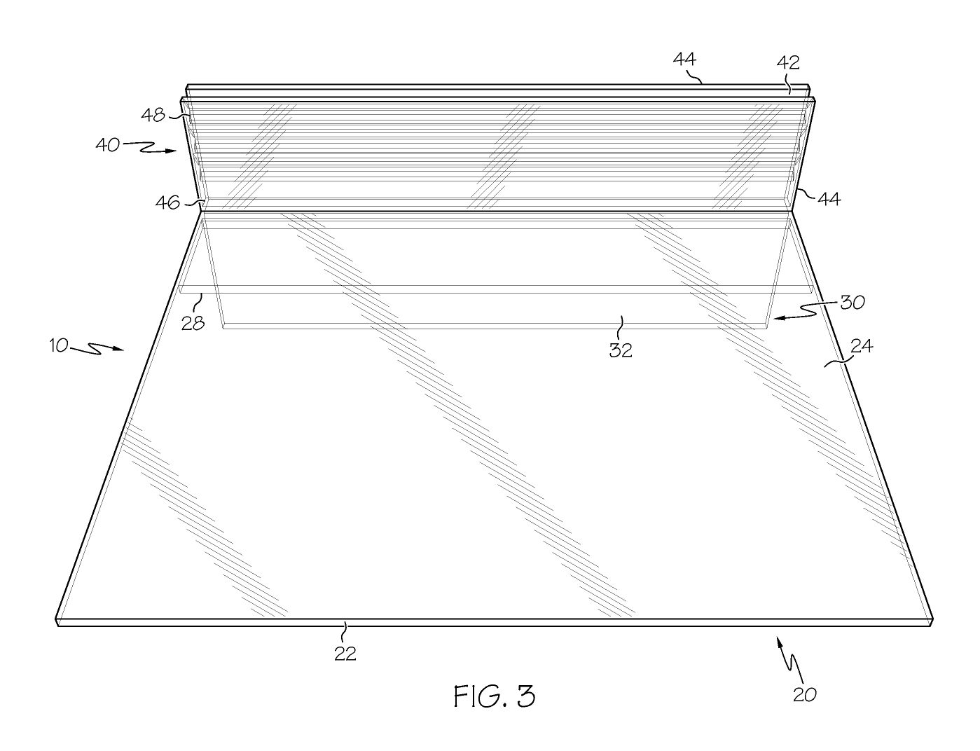

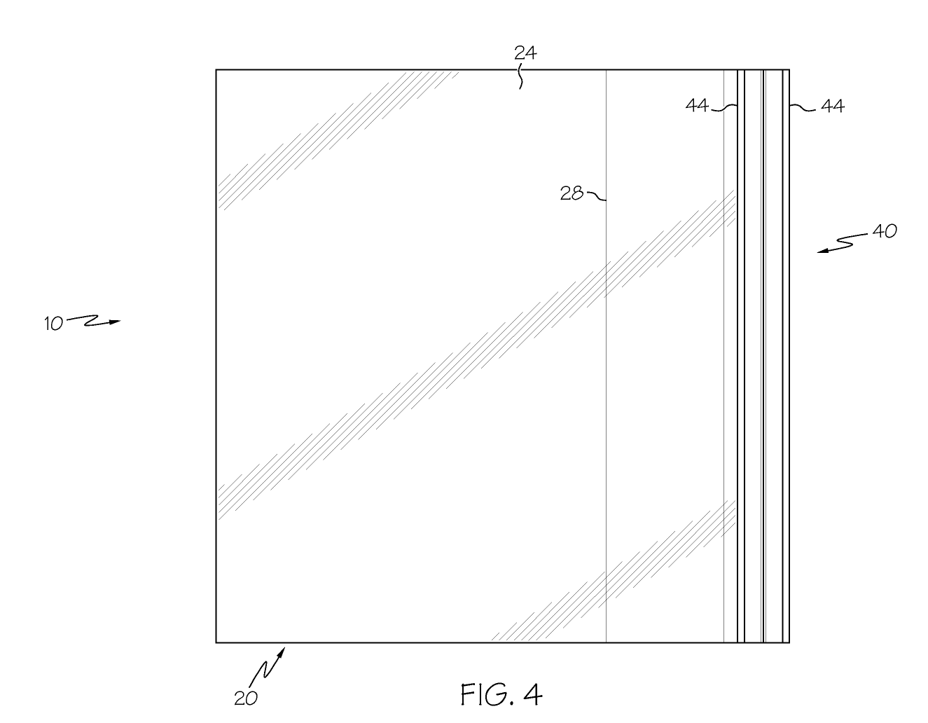

As shown in FIGS. 2-4, in one particular aspect, the adhesive 28 is substantially elongate. The shape of the adhesive 28 should not be limited to those disclosed herein, however, but may comprise any shape capable of securing the mounting plate 20 to the pallet 50. In another aspect, the adhesive 28 is adhered to the lower surface 26 of the mounting plate 20 such that when placed in contact with the pallet 50, the adhesive 28 contacts the horizontal members 52 of the pallet 50. However, the placement of the adhesive 28 should not be limited to that disclosed herein, but may comprise any placement on the mounting plate 20 such that when the adhesive 28 is placed in contact with the pallet 50, the mounting plate 20 becomes secured thereto.

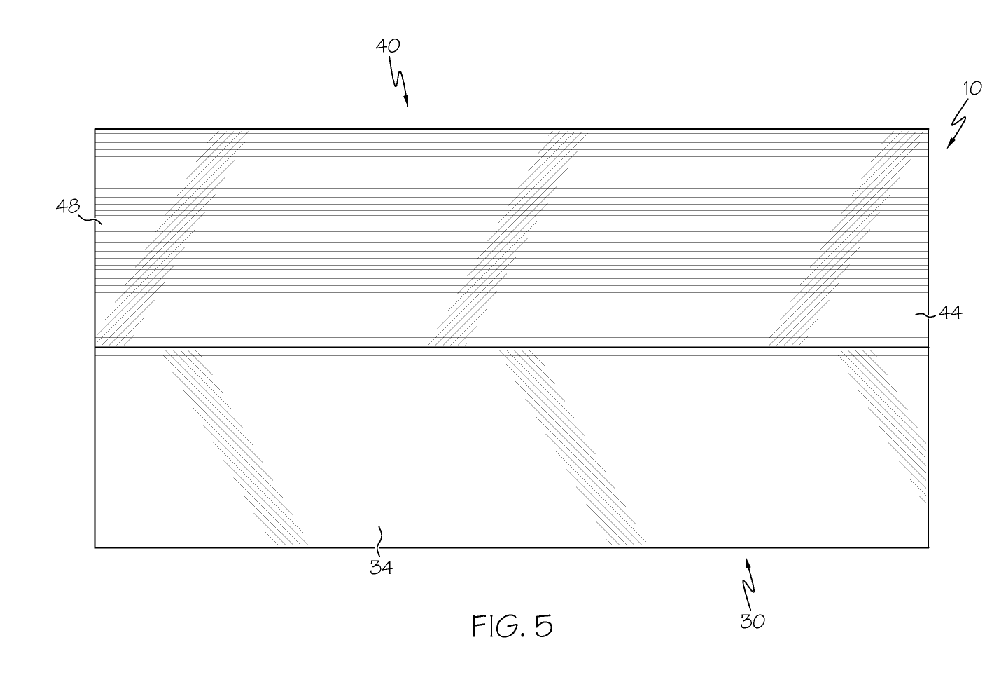

As shown in FIGS. 1, 2, and 5, in another aspect, the device 10 for holding signage 60 on a pallet 50 comprises a support plate 30. In one aspect, the support plate 30 is integral with the outer edge 22 of the mounting plate 20 and is substantially normal to the mounting plate 20. In one particular aspect, the support plate 30 comprises an inner surface 32 and an outer surface 34. In another aspect, the support plate 30 is substantially planar. In a further aspect, the support plate 30 is about 50 mm thick. It is understood by one skilled in the art, however, that the support plate 30 can be extruded to a variety of thicknesses to accommodate different needs. In another aspect, the support plate 30 is substantially elongate. In one particular aspect, the support plate 30 comprises plastics, polymers, rubbers, metals, and/or composites, and combinations thereof. In a further aspect, the support plate 30 is aluminum. In an alternative aspect, the support plate 30 comprises an extrudable plastic. In a further aspect, the extrudable plastic is polyethylene, polystyrene, and/or polytetrafluoroethylene, and combinations thereof. In one particular aspect, the support plate 30 is substantially transparent to light in the visible region (having a wavelength, λ, from about 400 nm to about 700 nm) of the electromagnetic spectrum. In an alternative aspect, the support plate 30 is substantially nontransparent to light in the visible region (having a wavelength, λ, from about 400 nm to about 700 nm) of the electromagnetic spectrum.

As previously mentioned, in one particular aspect, the mounting plate 20 is attachable to the pallet 50 such that the lower surface 26 of the mounting plate 20 engages the horizontal members 52 of the pallet 50. In this particular aspect, the mounting plate 20 is attached to the pallet 50 by inserting the mounting plate 20 beneath the transport goods, merchandise, and/or related inventory and translating the mounting plate 20 in a substantially horizontal direction toward the opposing edge of the pallet 50. In a further aspect, the mounting plate 20 translates in a substantially horizontal direction until the inner surface 32 of the support plate 30 engages the substantially rectangular frame 54 of the pallet 50.

As shown in FIGS. 1-5, the device 10 for holding signage 60 on a pallet 50 comprises a signage support unit 40. In one aspect, the signage support unit 40 comprises a channel 42 configured to hold signage 60 therein. In one particular aspect, the channel 42 is defined by a plurality of elongate members 44 and a base member 46. In one particular aspect, the elongate members 44 and the base member 46 are substantially planar. In a further aspect, the elongate members 44 and the base member 46 are about 50 mm thick. In still a further aspect, the length of the elongate members 44 is about 5 in and the width of the elongate members 44 is about 1.5 in. In still a further aspect, the width of the channel 42 is about 0.25 in and the depth of the channel 42 is about 1.25 in. It is understood by one skilled in the art, however, that the signage support unit 40 can be extruded to a variety of thicknesses, lengths, and widths to accommodate different needs.

In a further aspect, the plurality of elongate members 44 are substantially parallel, and the base member 46 is substantially normal to the elongate members 44, such that the signage support unit 40 is substantially U-shaped. However, the shape of the signage support unit 40 should not be limited to substantially U-shaped, but may comprise any shape wherein the signage support unit 40 is configured to hold signage 60 therein.

In a further aspect of this embodiment, the elongate members 44 are integral with the base member 46. In one particular aspect, the signage support unit 40 comprises plastics, polymers, rubbers, metals, and/or composites, and combinations thereof. In a further aspect, the signage support unit 40 is aluminum. In an alternative aspect, the signage support unit 40 comprises an extrudable plastic. In a further aspect, the extrudable plastic is polyethylene, polystyrene, and/or polytetrafluoroethylene, and combinations thereof. In one particular aspect, the signage support unit 40 is substantially transparent to light in the visible region (having a wavelength, λ, from about 400 nm to about 700 nm) of the electromagnetic spectrum. In an alternative aspect, the mounting plate 20 is substantially nontransparent to light in the visible region (having a wavelength, λ, from about 400 nm to about 700 nm) of the electromagnetic spectrum.

As shown in FIGS. 1 and 2, in one particular aspect, the signage support unit 40 comprises a plurality of flexible members 48. In one particular aspect, the plurality of flexible members 48 are disposed within the channel 42 configured to hold signage 60 therein. In one particular aspect, the flexible members 48 are substantially elongate. In a further aspect, the flexible members 48 are integral with the elongate members 44. In still a further aspect, the flexible members 48 form a substantially 45° angle, θ, with the elongate members 44. In yet still a further aspect, the flexible members 48 are arranged within the channel 42 in an alternating configuration.

In an alternative aspect, the flexible members 48 are disposed within the channel 42 configured to hold signage 60 therein, such that the flexible members 48 are integral with only one of the elongate members 44. In this particular aspect, the flexible members 48 disposed within the channel 42 are sufficiently elongate such that the flexible members 48 are capable of engaging signage 60 therein. In a further aspect, the flexible members 48 disposed within the channel 42 are integral with the elongate member 44 in an alternating configuration. In this particular aspect, the signage support unit 40 is substantially transparent to light in the visible region (having a wavelength, λ, from about 400 nm to about 700 nm) of the electromagnetic spectrum, such that signage 60 may be displayed through the signage support unit 40. In a further aspect, signage 60 may be displayed through the elongate members 44 of the signage support unit 40 which do not comprise flexible members 48.

The signage support unit 40 is integral with the support plate 30 and the outer edge 22 of the mounting plate 20, such that the signage support unit 40 is substantially normal to the mounting plate 20 and extends in a substantially vertical direction above the pallet 50. In one particular aspect, one of the elongate members 44 substantially aligns with the support plate 30 such that the signage support unit 40 does not overlap with the pallet 50. In an alternative aspect, one of the elongate members 44 substantially aligns with the support plate 30 such that the signage support unit 40 overlaps with the pallet 50.

In a further aspect of this embodiment, the signage 60 comprises at least one panel. In still a further aspect, the panel is substantially planar and substantially rectangular. The shape of the panel should not be limited to that disclosed herein, however, but may comprise any shape wherein the panel is held within the signage support unit 40.

It is understood that the signage 60 may comprise various text, graphics, images, and/or advertisements. It is also understood that the signage 60 may be blank. Additionally, it is also understood by one skilled in the art that the text, graphics, images and/or advertisements may be painted, drawn, screened, stenciled, or affixed to the signage 60. In one aspect, the signage 60 held within the signage support unit 40 is not permanently fixed to the signage support unit 40, such that the signage 60 may be interchanged with a different graphic indicia. In this way, the text, graphics, images, advertisements or lack thereof displayed on the signage 60 may be changed according to need.

In a further aspect of this embodiment, a plurality of mounting plates 20 are attached to the pallet 50. In one particular aspect, the plurality of mounting plates 20 are attached to the same side of the pallet 50. In an alternative aspect, the plurality of mounting plates 20 are attached to different sides of the pallet 50. In still another aspect, the plurality of mounting plates 20 are attached to the same side of the pallet 50 and/or to different sides of the pallet 50, and combinations thereof. In this particular aspect, the plurality of mounting plates 20 are attached to the pallet 50 such that signage 60 that is larger in size than the signage support unit 40 may be held within a plurality of signage support units 40. Additionally, in this particular aspect, the plurality of mounting plates 20 are attached to the pallet 50 such that signage 60 may be held within a plurality of signage support units 40 on different sides of the pallet 50.

In another embodiment, the present invention relates to a method of displaying signage 60 on a pallet 50 comprising utilizing the device 10 for holding signage 60 on a pallet 50 of the present invention.

Referring with particularity to FIG. 1, in another embodiment, the present invention relates to a method of displaying signage 60 on a pallet 50. In one aspect, the method of displaying signage 60 on a pallet 50 comprises attaching a mounting plate 20 to the pallet 50, positioning a signage support unit 40 that is integrally formed with the support plate 30 and comprises a channel 42 configured to hold signage 60 therein, and placing signage 60 within the channel 42 such that signage 60 is displayed on the pallet 50. In one particular aspect, the mounting plate 20 has an outer edge 22 such that a support plate 20 is integrally formed with the outer edge 22 of the mounting plate 20 and is substantially normal to the mounting plate 20. In another aspect, the signage support unit 40 is positioned such that the signage support unit 40 is substantially normal to the mounting plate 20 and extends in a substantially vertical direction above the pallet 50.

In yet another embodiment, the present invention relates to a pallet 50. The pallet 50 comprises a plurality of substantially horizontal members 52 attached to a rectangular frame 54, a mounting plate 20 attached to the at least one of the rectangular frame 54 and to the plurality of horizontal members 52, wherein the mounting plate 20 has an outer edge 22, a support plate 30 integral with the outer edge 22 of the mounting plate 20 and substantially normal to the mounting plate 20, and a signage support unit 40 comprising a channel 42 configured to hold signage 60 therein, wherein the signage support unit 40 is integral with the support plate 30 and the outer edge 22 of the mounting plate 20, such that the signage support unit 40 is substantially normal to the mounting plate 20 and extends in a substantially vertical direction above the pallet 50.

In a further aspect of this embodiment, the mounting plate 20 has an outer edge 22, an upper surface 24 and a lower surface 26. In one aspect, the mounting plate 20 is attachable to the pallet 50 with an adhesive 28. In one particular aspect, the adhesive 28 is disposed on the lower surface 26 of the mounting plate 20 such that when the adhesive 28 is placed in contact with the pallet 50, the mounting plate 20 becomes secured thereto. In one aspect, the adhesive 28 is selected from natural adhesives, synthetic adhesives, drying adhesives and contact adhesives. In a further aspect, the adhesive 28 is a synthetic adhesive. In still a further aspect, the adhesive 28 is a foam adhesive.

In one particular aspect, the adhesive 28 is substantially elongate. The shape of the adhesive 28 should not be limited to those disclosed herein, however, but may comprise any shape capable of securing the mounting plate 20 to the pallet 50. In another aspect, the adhesive 28 is adhered to the lower surface 26 of the mounting plate 20 such that when placed in contact with the pallet 50, the adhesive 28 contacts the horizontal members 52 of the pallet 50. However, the placement of the adhesive 28 should not be limited to that disclosed herein, but may comprise any placement on the mounting plate 20 such that when the adhesive 28 is placed in contact with the pallet 50, the mounting plate 20 becomes secured thereto.

In a further aspect of this embodiment, the signage support unit 40 comprises a channel 42 configured to hold signage 60 therein. In one particular aspect, the channel 42 is defined by a plurality of elongate members 44 and a base member 46. In a further aspect, the plurality of elongate members 44 are substantially parallel, and the base member 46 is substantially normal to the elongate members 44, such that the signage support unit 40 is substantially U-shaped. However, the shape of the signage support unit 40 should not be limited to substantially U-shaped, but may comprise any shape wherein the signage support unit 40 is configured to hold signage 60 therein.

In a further aspect, the elongate members 44 are integral with the base member 46. In one particular aspect, the signage support unit 40 comprises plastics, polymers, rubbers, metals, and/or composites. In a further aspect, the signage support unit 40 is aluminum. In an alternative aspect, the signage support unit 40 comprises an extrudable plastic. In a further aspect, the extrudable plastic is polyethylene, polystyrene, and/or polytetrafluoroethylene, and combinations thereof.

In one particular aspect, the signage support unit 40 comprises a plurality of flexible members 48. In one particular aspect, the plurality of flexible members 48 are disposed within the channel 42 configured to hold signage 60 therein. In one particular aspect, the flexible members 48 are substantially elongate. In a further aspect, the flexible members 48 are integral with the elongate members 44. In still a further aspect, the flexible members 48 form a substantially 45° angle, θ, with the elongate members 44. In yet still a further aspect, the flexible members 48 are arranged within the channel 42 in an alternating configuration.

For the purposes of describing and defining the present invention it is noted that the terms “about” and “substantially” are utilized herein to represent the inherent degree of uncertainty that may be attributed to any quantitative comparison, value, measurement, or other representation. The terms “about” and “substantially” are also utilized herein to represent the degree by which a quantitative representation may vary from a stated reference without resulting in a change in the basic function of the subject matter at issue.

The above description and drawings are only to be considered illustrative of exemplary embodiments, which achieve the features and advantages of the present invention. Modification and substitutions the features and steps described can be made without departing from the intent and scope of the present invention. Accordingly, the invention is not to be considered as being limited by the foregoing description and drawings, but is only limited by the scope of the appended claims.

What is claimed is:

1. A device for holding signage on a pallet, the device comprising:
a mounting plate attachable to the pallet and having an outer edge;
a support plate integral with the outer edge of the mounting plate and substantially normal to the mounting plate; and
a signage support unit comprising a channel configured to hold signage therein, wherein the signage support unit is integral with the support plate and the outer edge of the mounting plate, such that the signage support unit is substantially normal to the mounting plate and extends in a substantially vertical direction above the pallet.

2. The device of claim 1, wherein the signage support unit comprises a plurality of elongate members integral with a base member.

3. The device of claim 2, wherein the plurality of elongate members are substantially parallel to one another, and the base member is substantially normal to the plurality of elongate members such that the signage support unit is substantially U-shaped.

4. The device of claim 1, wherein the signage support unit comprises a plurality of flexible members within the channel configured to hold signage therein.

5. The device of claim 4, wherein the plurality of flexible members are integral with the plurality of elongate members.

6. The device of claim 5, wherein the flexible members form a substantially 45° angle with the plurality of elongate members.

7. The device of claim 5, wherein the plurality of flexible members are arranged within the channel in an alternating configuration.

8. The device of claim 1, wherein the mounting plate comprises an upper surface and a lower surface.

9. The device of claim 8, further comprising an adhesive disposed on the lower surface such that when the adhesive is placed in contact with the pallet, the mounting plate becomes secured thereto.

10. The device of claim 9, wherein the adhesive is a foam adhesive.

11. The device of claim 1, wherein the device comprises a metal.

12. The device of claim 11, wherein the metal is aluminum.

13. The device of claim 1, wherein the device comprises an extrudable plastic.

14. The device of claim 13, wherein the extrudable plastic is selected from the group consisting of polyethylene, polystyrene, and polytetrafluoroethylene.

15. A method of displaying signage on a pallet which comprises utilizing the device of claim 1.

16. A method of displaying signage on a pallet, the method comprising:
attaching a mounting plate having an outer edge to the pallet such that a support plate is integrally formed with the outer edge of the mounting plate and substantially normal to the mounting plate;
positioning a signage support unit that is integrally formed with the support plate and comprises a channel configured to hold signage therein such that the signage support unit is substantially normal to the mounting plate and extends in a substantially vertical direction above the pallet; and
placing signage within the channel, such that signage is displayed on the pallet.

17. A pallet comprising:
a plurality of substantially horizontal members attached to a substantially rectangular frame;
a mounting plate attached to at least one of the rectangular frame and to the plurality of substantially horizontal members,
wherein the mounting plate has a outer edge;
a support plate integral with the outer edge of the mounting plate and substantially normal to the mounting plate; and
a signage support unit comprising a channel configured to hold signage therein, wherein the signage support unit is integral with the support plate and the outer edge of the mounting plate, such that the signage support unit is substantially normal to the mounting plate and extends in a substantially vertical direction above the pallet.

18. The pallet of claim 17, wherein the signage support unit comprises a plurality of elongate members substantially parallel to one another, and a base member substantially normal to the plurality of elongate members, such that the signage support unit is substantially U-shaped.

19. The pallet of claim 17, wherein the signage support unit comprises a plurality of flexible members within the channel configured to hold signage therein.

20. The pallet of claim 17, wherein the mounting plate comprises an upper surface and a lower surface, wherein the lower surface comprises an adhesive, such that the mounting plate may be attached to the pallet.
